(19) United States
(12) Patent Application Publication
(10) Pub. No.: US 2015/0075346 A1
(43) Pub. Date: Mar. 19, 2015

(54) Saw Band With a Profiled Back

(71) Applicant: WIKUS-Saegenfabrik Wilhelm H. Kullmann GmbH & Co. KG, Spangenberg (DE)

(72) Inventors: Joerg H. Kullmann, Spangenberg (DE); Patrick Gleim, Homberg/Efze (DE); Christoph Siel, Rotenburg an der Fulda (DE)

(21) Appl. No.: 14/486,151

(22) Filed: Sep. 15, 2014

(30) Foreign Application Priority Data
Sep. 13, 2013 (DE) 10 2013 110 120.8

(51) Int. Cl. B23D 61/12

(52) U.S. Cl. CPC B23D 61/123
USPC 83/661

(57) ABSTRACT

A saw band (1) includes a tooth supporting body (2), a plurality of teeth (3) being located at the tooth supporting body (2) and a back (4) being located opposite to the teeth (3). The back (4) includes a profiled back portion (5). The profiled back portion (5) includes an inclination portion (6), a declination portion (7) and a compensation portion (8). The declination portion (7) is located next to the end of the inclination portion (6) and the compensation portion (8) is located next to the end of the declination portion (7). Alternatively, the inclination portion (6) is located next to the end of the declination portion (7) and the compensation portion (8) is located next to the end of the inclination portion (6), the length of the compensation portion (8) being shorter than length of the inclination portion (6) and the length of the declination portion (7).

### CROSS REFERENCE TO RELATED APPLICATIONS

This application claims priority to co-pending German Patent Application No. DE 10 2013 110 120.8 entitled “Sägeband mit profiliertem Bandrücken”, filed Sep. 13, 2013.

### FIELD OF THE INVENTION

The present invention generally relates to a saw band including a tooth supporting body and a plurality of teeth being arranged at the tooth supporting body. Opposite to the teeth, the saw band includes a back having a profiled back portion.

The back of the band thus does not extend in the usual straight direction of movement of the band, but it is designed to be profiled, and it includes a plurality of portions extending at different angles with respect to the usual straight direction of movement of the band.

### BACKGROUND OF THE INVENTION

Saw bands having a straight and non-profiled back extending in the usual straight direction of movement of the band are generally known in the art. Such a design results in a uniform feed rate, always the same feed direction and constant cutting forces. Cold work hardened zones are produced in the material of the workpiece to be cut during sawing. Such zones cannot be undercut with such a known saw band. Many teeth are always in full contact in the sense of cutting. In this way, there are great cutting forces, great wear and tear and thus a decreased lifetime of the saw band.

A saw band including a tooth supporting body and a plurality of teeth being arranged at the tooth supporting body is known from German Patent No. DE 697 17 699 T2 corresponding to U.S. Pat. No. 6,532,852 B1. The back of the band opposite to the teeth includes a profiled back having different portions. According to most of the embodiments shown in this document, the profiled back is designed to be wave-like such that a plurality of curved surfaces are located one next to the other. As it is to be seen in FIG. 1A, for example, the profiled back includes an inclination portion, which is directly followed by a plateau portion, which is directly followed by a declination portion, which is directly followed by a bottom portion. All of these portions are designed to be curved. The inclination portion and the declination portion have the same bending radius.

A separate embodiment according to FIG. 10A of German Patent No. DE 697 17 699 T2 shows a straight inclination portion, which is directly followed by a straight plateau portion, which is directly followed by a straight declination portion, which is directly followed by a straight bottom portion. The inclination portion and the declination portion have the same length and an identical absolute value of the angle of inclination and declination, respectively. The plateau portion and the bottom portion have the same length. This length is identical to the sum of the lengths of the inclination portion and of the declination portion.

Different embodiments of saw bands including a tooth supporting body and a plurality of teeth being arranged at the tooth supporting body are known from international patent application WO 2006/019129 A1 corresponding to US patent application No. US 2008/0121079 A1. A back having a profiled back portion is arranged opposite to the teeth. Different embodiments of the profiled band back of different embodiments of the saw band are especially illustrated in FIGS. 6, 11, 13 and 15.

A saw band including a tooth supporting body and a plurality of teeth being arranged at the tooth supporting body is known from French Patent Application No. FR 2 369 048 A1. Opposite to the teeth, the saw band includes a back having a profiled back portion. The profiled back includes a declination portion, which is directly followed by an inclination portion, which is directly followed by a declination portion.

### SUMMARY OF THE INVENTION

The present invention relates to a saw band including a tooth supporting body, a plurality of teeth being located at the tooth supporting body and a back being located opposite to the teeth. The back includes a profiled back portion. The profiled back portion includes an inclination portion, a declination portion and a compensation portion. The inclination portion has a first length, a first end and a first angle of inclination. The inclination portion is designed and arranged such that a distance of the back to the teeth increases in the inclination portion in a direction towards the first end of the inclination portion. The declination portion has a second length, a second end and a second angle of declination. The declination portion is designed and arranged such that a distance of the back to the teeth decreases in the declination portion in a direction towards the second end of the declination portion. The compensation portion has a third length and a third end. The compensation portion is designed not to be profiled and to be straight such that a distance of the back to the teeth is constant in the compensation portion. The declination portion is located next to the first end of the inclination portion and the compensation portion is located next to the second end of the declination portion. Alternatively, the inclination portion is located next to the second end of the declination portion and the compensation portion is located next to the first end of the inclination portion, the third length of the compensation portion being shorter than first length of the inclination portion and the second length of the declination portion.

The back of the saw band is profiled in a special way to impart different directions of movement other than the usual direction of movement of the band during sawing. The saw band is thus tilted alternatingly clockwise and counterclockwise. This movement results from contact to the guiding elements of the saw machine to the non-straight profiled portion of the back of the saw band.

Due to this tilting movement, there is a discontinuous feed and an aggressive cutting behavior of the saw band. A cold work hardened zone can be produced in the material to be cut due to the cutting pressure. Due to the aggressive cutting behavior, this cold work hardened zone is undercut. The novel profiled portion of the back of the band results in varying cutting forces. The average cutting forces can however be substantially lower compared to a saw band having a straight back. In this way, wear and tear is reduced. Due to the tilting movement, the active length of the saw band is reduced, meaning that less teeth are simultaneously in contact with the material to be cut, the cutting channel is shortened and the cutting forces are reduced. In this way, one attains a good surface quality with reduced roughness values and good straightness of the cut workpiece.

The inclination portion and the declination portion serve to tilt the saw band in opposite directions and are thus also designated as tilting portions. The compensation portion alone would not cause such a tilting movement. However, it is designed and arranged such that it is not active alone and not with another compensation portion, respectively, but only in combination with the inclination portion or the declination portion. This means that one of the guiding elements of the band saw machine contacts the compensation portion and another guiding element simultaneously contacts the inclination portion or the declination portion. In this way, there is the tilting movement of the respective tilting portion—i.e. the inclination portion or the declination portion. The compensation portion decouples the inclination portion and the declination portion from one another. In this way, the tilting movement slows down towards its ending. The transition between the inclination portion and the declination portion is less abrupt due to the intermediate arrangement of the compensation portion such that there is no abrupt increase of cutting forces and the load acting upon the teeth is thus reduced.

The compensation portion increases the effect of the tilting movement of the saw band without having to reduce the height difference between the highest point of the inclination portion and the lowest point of the declination portion. The risk of breakage of the band is reduced due to the decreased weakening of the saw band.

The compensation portion or decoupling portion may be designed as a lowered portion—i.e. a portion being located closer to the teeth of the saw band. However, it can alternatively be a raised portion. Only one of these two portions is arranged—i.e. the lowered compensation portion or the raised compensation portion. In this way, it is ensured that always one tilting portion is effective—i.e. it is in contact with a guiding element of the saw machine—such that the desired tilting movement is realized. In case two non-tiling portions were simultaneously active, there was no continued tilting movement.

In a preferred exemplary embodiment, the profiled back portion includes exactly these three above described portions—i.e. only the inclination portion, the declination portion and the compensation portion. The portions are arranged in the order “inclination portion-declination portion-compensation portion” or “inclination portion-compensation portion-declination portion” in a way that these portions are located directly adjacent to one another. The next profiled back portion including the same portions is then located next to this portion.

The compensation portion if preferably designed to be straight. However, it can also be designed as a curved surface having a huge radius. The inclination portion and the declination portion are also preferably designed to be straight, but they can also be designed as curved surfaces having a huge radius. These portions are located substantially directly adjacent to one another. However, it is also possible that a short straight portion or a short curved portion having a comparatively great radius is arranged in between.

The compensation portion may have a length of more than approximately 30 mm. In this way, it is ensured that the compensation portion can fulfill its buffer function between the inclination portion and the declination portion in case of usual guiding elements of band saw machines. A usual diameter of a guiding element being designed as a single roller is approximately 30 mm. A usual guiding element being designed as a double roller has a width of the roller unit being formed by this double roller of approximately 70 mm.

The length of the compensation portion may be especially more than approximately 50, 60, 80 or 100 mm. The length is especially shorter than approximately 150 mm and especially shorter than approximately 120 mm. The length may be between approximately 60 and 100 mm or between approximately 70 to 90 mm, especially approximately 80 mm.

The inclination portion may have an inclination angle having a different absolute value than the declination portion. In this way, the tilted direction of movement of the saw band compared to the usual direction of movement of the band is attained when the inclination portion and the declination portion simultaneously contact the respective guiding element of the band saw machine. This design is also designated as non-symmetric profiling. However, it is also possible to realize symmetric profiling in which the inclination portion and the declination portion have inclination angles (and declination angles, respectively) having the same absolute value.

The inclination portion and the declination portion may each be arranged at an angle with respect to the horizontal line (which corresponds to the usual straight direction of movement of the band) the absolute value of which is less than approximately 2°. The angle may be especially between approximately 0.1° and 1.0°. In case of non-symmetric profiling, the difference between these absolute values of the two angles is between approximately 0.2° and 0.9°. The inclination portion may have an angle of approximately 1.0° or less. The declination portion then has an angle of approximately 0.5° or less. This design ensures that the desired tilting movement is realized, on the one hand, and the transition between the compensation portion and the respective tilting portion is not too abrupt and thus does not lead to abrupt loads during sawing, on the other hand.

The declination portion may have a length being at least twice as long as the length of the inclination portion. Correspondingly, it has an angle of declination the absolute value of which is smaller than the one of the inclination portion. In this way, non-symmetric profiling of the profiled back portion can be realized well.

The saw band may include an integer plurality of profiled back portions. In this way, during circulation of the saw band through the band saw machine, one attains a uniform total movement including the partial movements being defined by the profiled back portion. The profiled back portions are dimensioned in a way that their integer arrangement along the length of the saw band is possible. The length of the profiled back portions is varied to adapt to the respective length of the band. This length of the band preferably is an integer multiple of the length of the profiled back portion. If all profiled back portions have the same design, this is designated as a fixed division.

However, it is also possible to use a variable division in which the saw band includes at least two profiled back portions having different lengths. This variable division may be realized in different ways. It is especially attained by the length of the respective longer tilting portion—i.e. the inclination portion or the declination portion—being enlarged and being shortened, respectively.

The profiled back portion may be produced such that the machining grooves resulting therefrom extend in a longitudinal direction of the saw band. This means that they extend parallel to the usual non-tilted direction of movement of the band. In this way, the danger of band breakage is substantially reduced. The profiled back portion may be produced especially by milling or grinding.

The transitions between the different portions of the profiled back portion may be formed by comparatively great radii—especially radii of approximately 50 mm or more-to reduce the notch effect, to attain a smoother movement of the saw band and to improve the continuous operation properties. In this way, noise emission during sawing is substantially reduced.

The tooth supporting body at its side facing away from the teeth may be designed not to be profiled apart from the teeth. In other words, the tooth side is especially designed not to be profiled, but it has the basic shape of a usual straight design.

The teeth may be arranged in a group of teeth being repeated along the tooth supporting body. The group may include the following teeth: a surface tooth C3 having the greatest width and the smallest height in the group and two performance teeth C1, C2 having greater heights and smaller widths than the surface tooth C3.

The performance tooth C1 having the greatest height and the smallest width may be arranged more than once in the group and/or the surface tooth C3 may be arranged more than once in the group. Especially, the group may include the performance tooth C1 twice, the surface tooth C3 twice and the performance tooth C2 only once, especially in the order C1-C3-C1-C2-C3. This special design is adapted to the novel design of the profiled back portion.

If a group of teeth known from the prior art is used in the novel saw band having the novel profiled back portion, it has been found that the teeth C1 and C3 participate in chipping in an increased way and thus wear out in a respectively shorter period of time. In contrast, the tooth C2 participates less in chipping. The above described novel arrangement of five teeth now allows to arrange the teeth C1 and C3 more frequently such that wear and tear is substantially reduced and the lifetime of the saw band is significantly increased.

At least a part of the teeth may have a rake angle of approximately 10° or more, especially approximately 12° or more and a clearance angle of approximately 18° or more, especially approximately 20° or more. In this way, the cutting wedge is designed to be thinner and to be thus more aggressive. In this way, the cutting forces are reduced and cold work hardening of the material of the workpiece to be sawed is counteracted. Due to the increased rake angle, less chip deforming work has to be performed. Due to the increased clearance angle, frictional forces in the chipping process are reduced.

The tooth supporting body and the base of the teeth are preferably made of metal, especially tempered steel. The cutting edge and at least a further part of the tips of the teeth is also made of metal, especially alloyed tool steel and high-speed steel, respectively, or abrasive cutting materials such as carbides, cermet, ceramic cutting materials or diamond. This material is harder than the material of the tooth supporting body such that the saw band is especially suitable for sawing metals. The teeth can also include a hard coating serving to increase resistance against wear and tear. However, it is also possible to cut other materials—especially wood or plastics—with the saw band.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if a profiled back portion is mentioned, this is to be understood such that there is exactly one profiled back portion, two profiled back portions or more profiled back portions. Additional features may be added to these features, or these features may be the only features of the respective product.

### BRIEF DESCRIPTION OF THE DRAWINGS

In the following, the invention is further explained and described with reference to preferred exemplary embodiments illustrated in the drawings.

FIG. 1 illustrates a first side view of a first exemplary embodiment of the novel saw band.

FIG. 2 illustrates a second side view of the saw band according to FIG. 1 at a smaller scale.

FIG. 3 illustrates a third side view of the saw band according to FIG. 1 in a partly broken illustration.

FIG. 4 illustrates a first side view of a second exemplary embodiment of the novel saw band.

FIG. 5 illustrates a second side view of the saw band according to FIG. 4 at a smaller scale.

FIGS. 6A-6E illustrate different positions of the novel saw band at guiding elements of a saw machine.

FIGS. 7A-7E illustrate different positions of the novel saw band at guiding elements of a saw machine.

FIG. 8 illustrates a position of the novel saw band at guiding elements of a saw machine.

FIG. 9 illustrates a position of the novel saw band at guiding elements of a saw machine.

FIG. 10 illustrates a first side view of another exemplary embodiment of the novel saw band.

FIG. 11 illustrates a second side view of the saw band according to FIG. 10 at a smaller scale.

FIG. 12 illustrates the toothed portion of the novel saw band in a projection in the direction of movement of the band.

### DETAILED DESCRIPTION

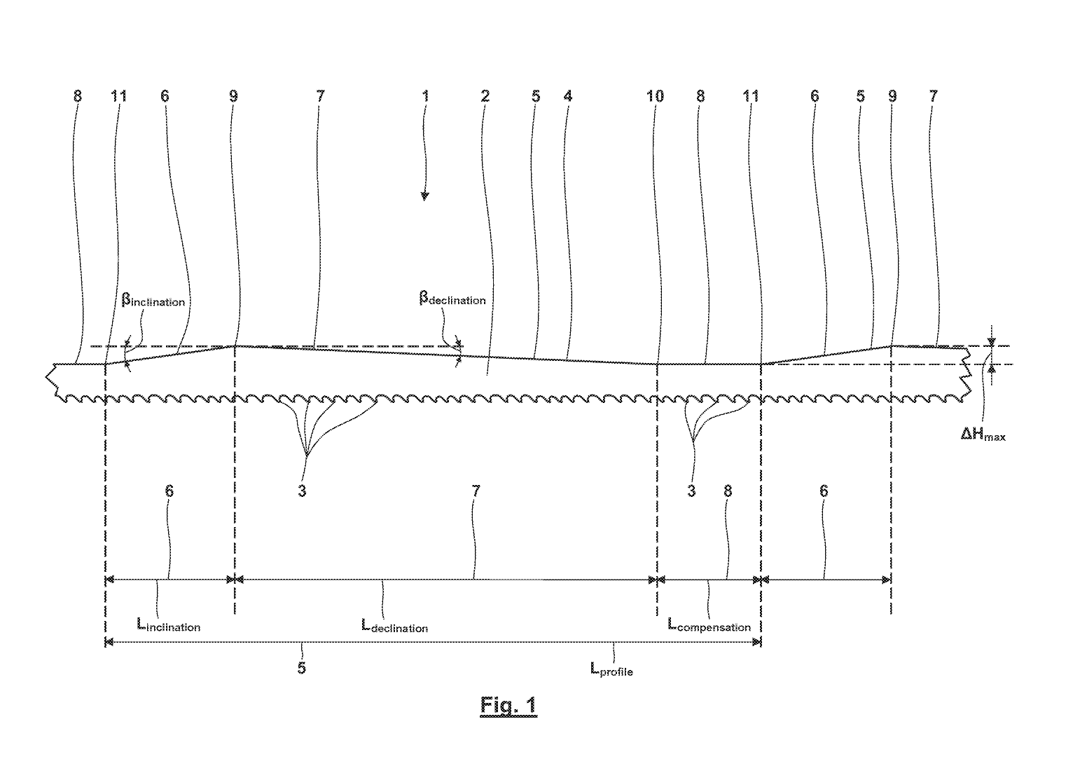

FIGS. 1-12 illustrate different views of parts of an exemplary embodiment of a novel saw band 1.

The views are true to scale such that the geometric relations between the single elements of the saw band can be determined from the drawings. This also applies with one restriction to the profiled back portion illustrated in FIGS. 1-11. This portion is enlarged by the scale of 15:1 in the direction perpendicular to the direction of movement of the saw band illustrated in the drawings (i.e. the usual direction Y) to improve recognizability of the profiling of the back of the band. This enlargement only relates to the profiled section of the back of the band and thus not to the distance between the lowest point of the back of the band and the teeth.

FIG. 1 illustrates a part of an elongated saw band 1 which is to be seen from the jagged lines in the left portion and the right portion of the illustration in FIG. 1. The saw band 1 includes a tooth supporting body 2 and a plurality of teeth 3 being arranged at the tooth supporting body 2. The saw band 1 further includes a back 4 being arranged opposite to the teeth 3 and including a profiled back portion 5.

The profiled back portion 5 includes an inclination portion 6. The back portion 4 is designed to be profiled in the inclination portion 6 such that its distance to the teeth 3 increases. The profiled back portion 5 furthermore includes a declination portion 7 being located next to the upper end 9 of the inclination portion 6. The back 4 is designed to be profiled in the declination portion 7 such that its distance to the teeth 3 decreases. A compensation portion 8 is then located next to the lower end 10 of the declination portion 7. The back 4 is designed to non-profiled and to be straight in the compensation portion 8 such that its distance to the teeth 3 is constant.

The compensation portion 8 up to its end 11 extends in the direction corresponding to the usual straight direction of movement of a saw band having a straight back. In contrast, the inclination portion 6 is arranged to be inclined at an inclination angle β_{inclination} with respect to the usual direction of movement of the band. The declination portion 7 is arranged to be declined at an angle β_{inclination} with respect to the usual direction of movement of the band. Due to the above described partial enlargement of the illustration of the drawing, these angles are actually substantially smaller.

The exemplary embodiment illustrated in FIG. 1 includes an asymmetrical profiling in which the absolute value of the inclination angle β_{inclination} is substantially greater than the one of the declination angle β_{declination}. Correspondingly, the length of the declination portion 7 as measured parallel to the usual direction of movement of the band is also substantially longer than the respective length of the inclination portion 6. The compensation portion 8 has an even shorter length.

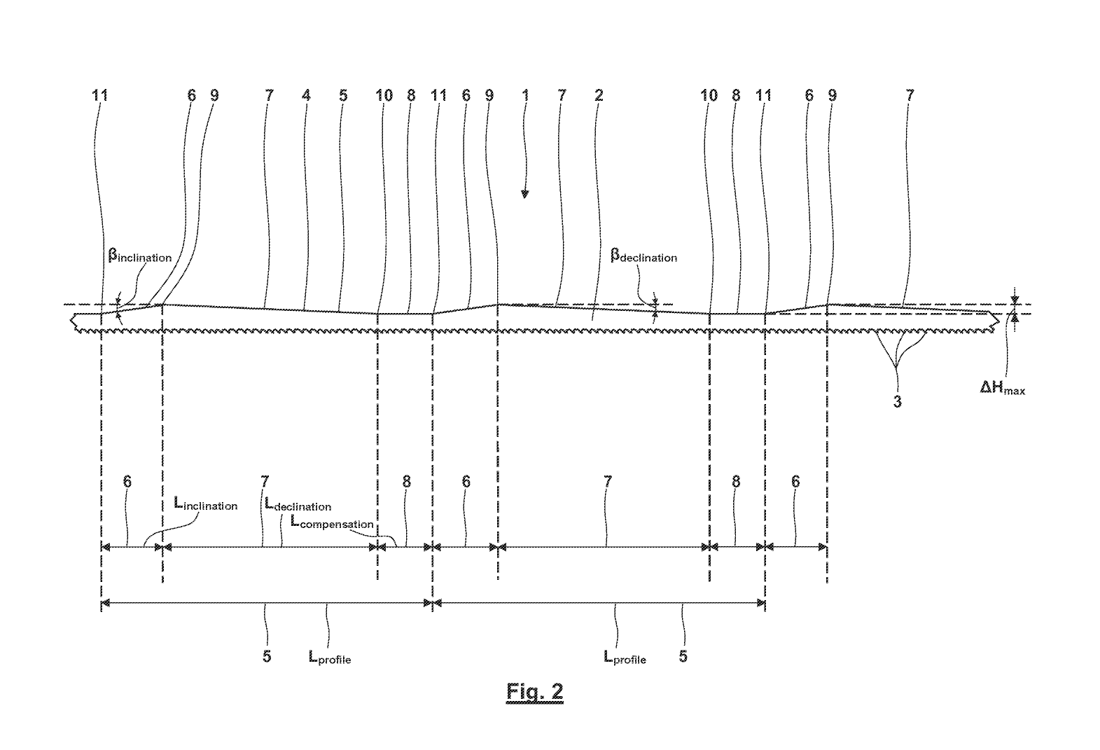

FIG. 2 illustrates another view of the first exemplary embodiment of the saw band 1 according to FIG. 1. In this case, the scale has been chosen such that two profiled portions 5 are fully illustrated.

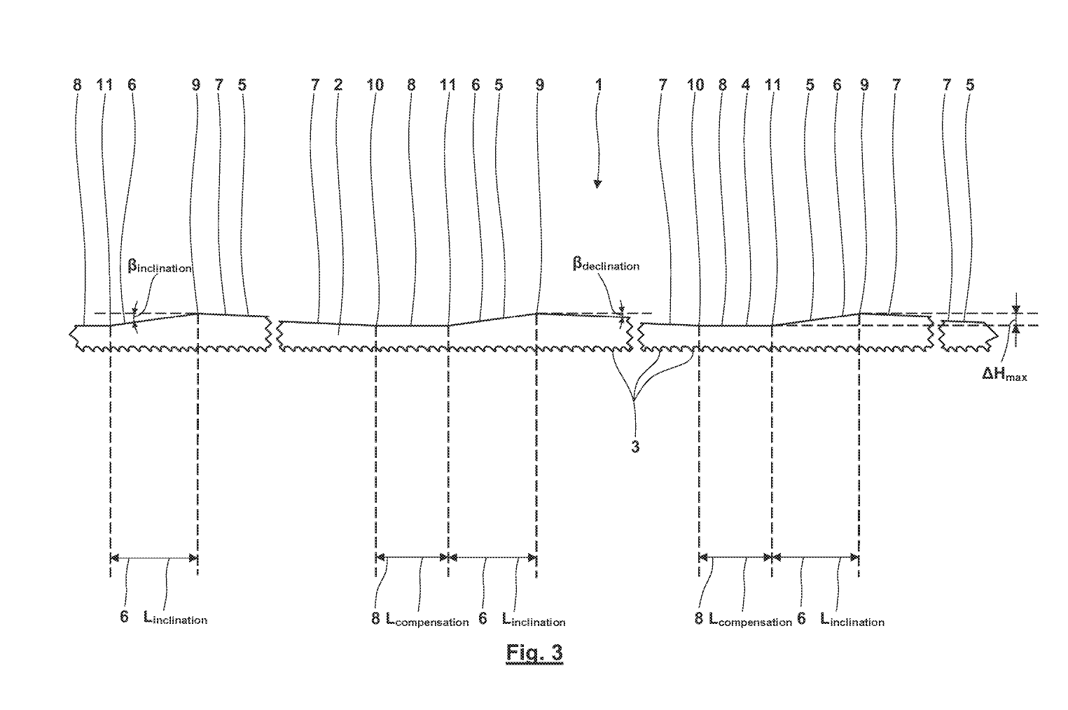

FIG. 3 illustrates another view of the first exemplary embodiment of the saw band 1 according to FIG. 1. In this case, a partly broken illustration has been used such that it can be seen that more than two profiled portions 5 are arranged along the length of the saw band 1.

The following table lists the respective values of this exemplary embodiment:

Exemplary embodiment No. 1

| | | Value |
|---|---|---|
| Parameter | Unit | (absolute value) |
| inclination angle β_{inclination} | ° | 0.69 |
| declination angle β_{declination} | ° | 0.21 |
| length of the inclination portion L_{inclination} | mm | 100 |
| length of the declination portion L_{declination} | mm | 320 |
| length of the compensation portion L_{compensation} | mm | 80 |
| length of the profiled back portion L_{profile} | mm | 500 |
| maximum height difference ΔHₘₐₓ | mm | 1.2 |

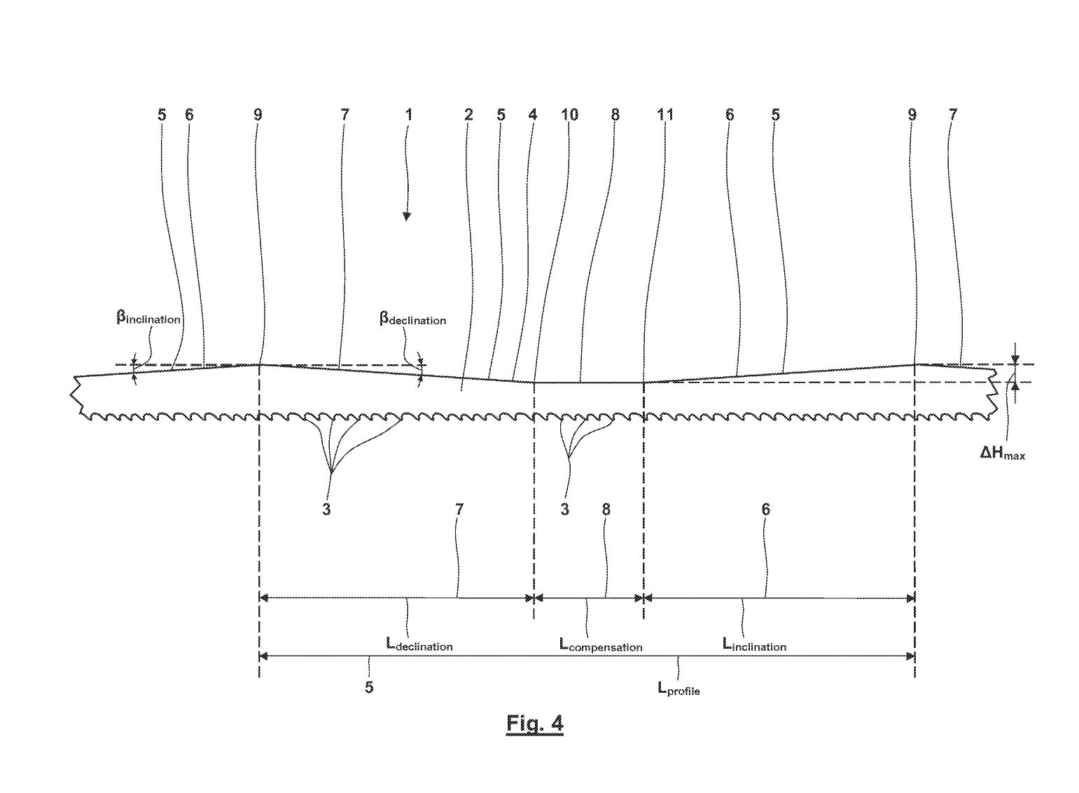

FIGS. 4 and 5 show illustrations corresponding to the ones of FIGS. 1 and 2, but showing a second exemplary embodiment of the novel saw band 1. In this case, the back 4 includes a symmetrically profiled profile back portion 5. This means that the inclination portion 6 and the declination portion 7 have the same length and their angle of inclination and declination, respectively, have the same absolute value.

The following table lists the respective values of this exemplary embodiment:

Exemplary embodiment No. 2

| | | Value |
|---|---|---|
| Parameter | Unit | (absolute value) |
| inclination angle β_{inclination} | ° | 0.33 |
| declination angle β_{declination} | ° | 0.33 |
| length of the inclination portion L_{inclination} | mm | 210 |
| length of the declination portion L_{declination} | mm | 210 |
| length of the compensation portion L_{compensation} | mm | 80 |
| length of the profiled back portion L_{profile} | mm | 500 |
| maximum height difference ΔHₘₐₓ | mm | 1.2 |

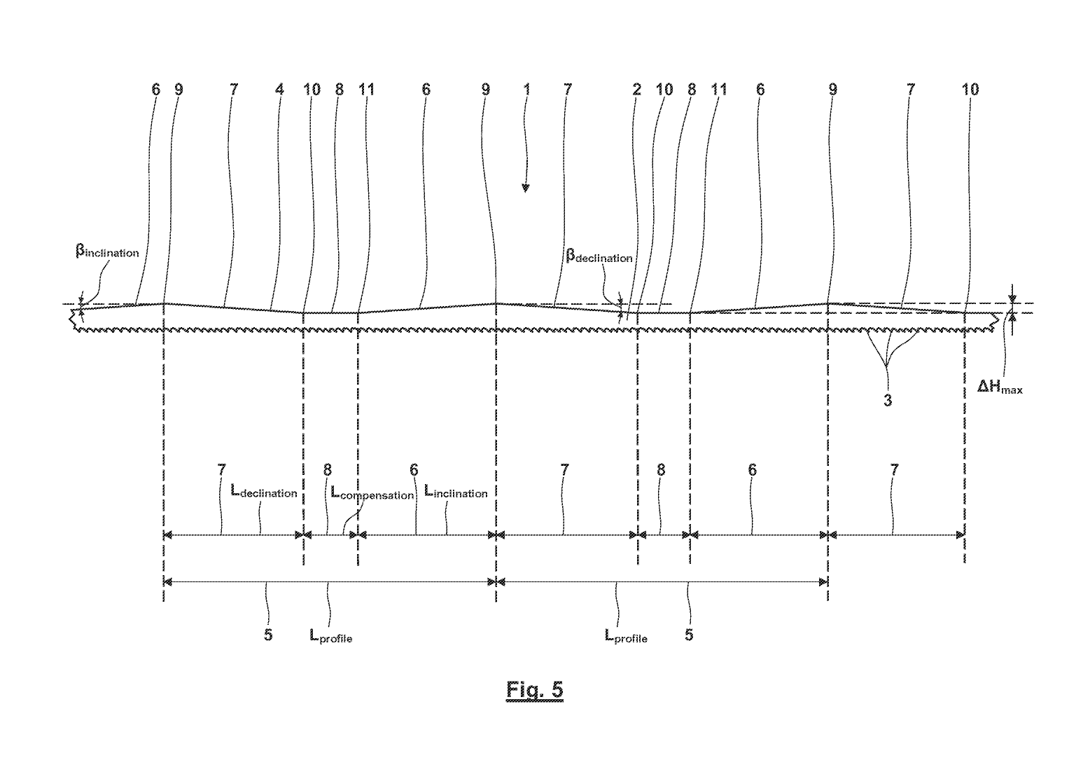

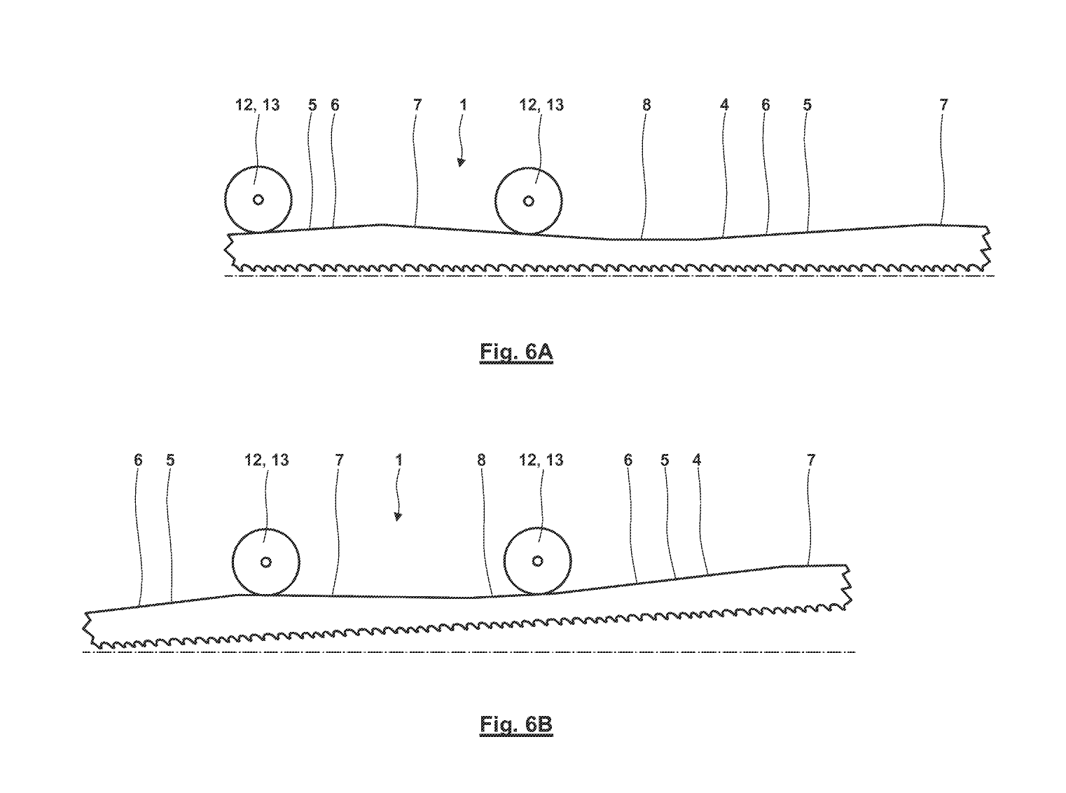

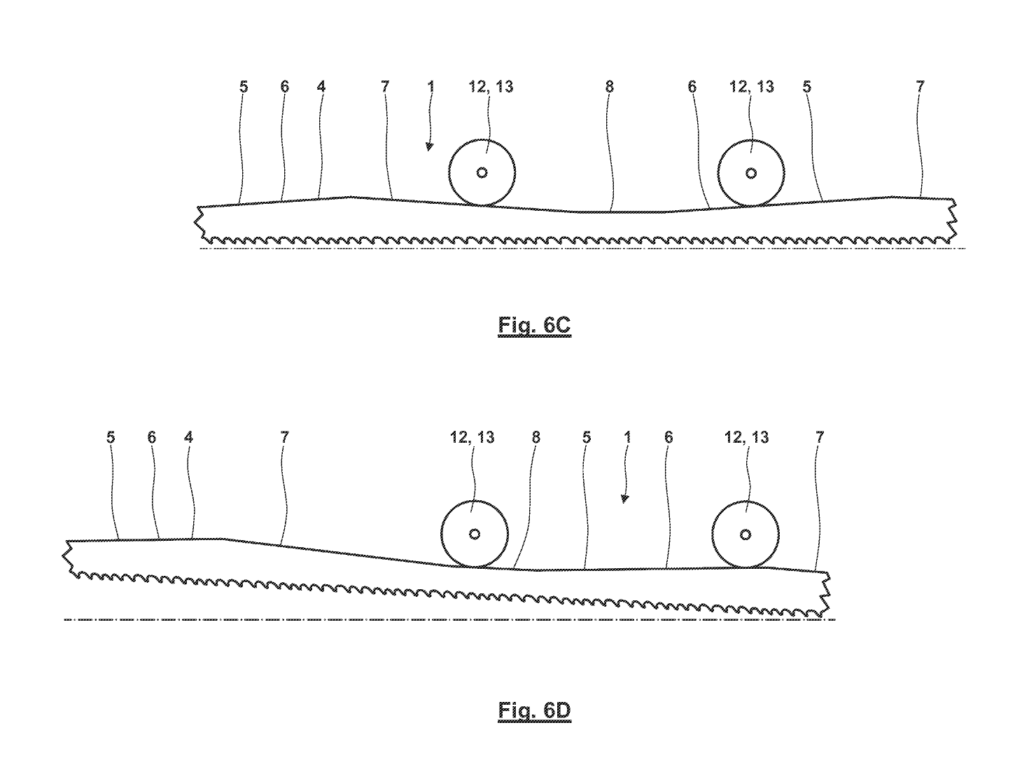

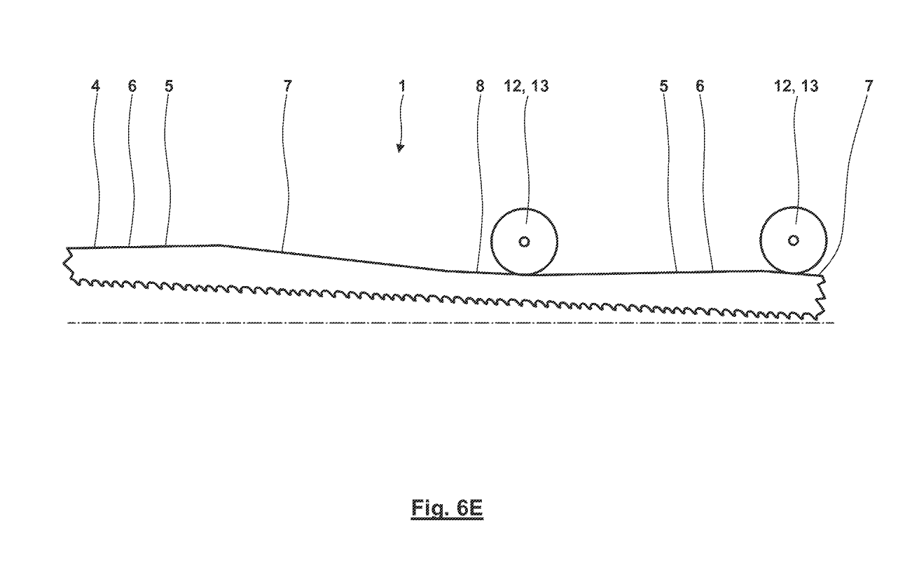

FIGS. 6A-6E illustrate the novel kind of movement of the saw band 1 in a saw machine. This saw machine itself has a usual design such that a detailed illustration and description is not required. In this case, the saw band 1 includes a symmetrically profiled back portion 5. The compensation portion 8 is designed as a lowered portion.

The saw machine includes guiding elements 12. In this case, each guiding element 12 is designed as a single roller 13. The back 4 and thus the saw band 1 is guided by these guiding elements 12 in the region of the workpiece to be cut (not illustrated). The workpiece to be cut is located between the guiding elements 12. In the illustration of FIG. 6, the saw band 1 moves in the right direction. The usual direction of movement of a saw band not being profiled is illustrated by the dash-dot line.

The non-straight direction of movement of the saw band 1 results from the contact of the profiled back 4 to the guiding elements 12.

In the position illustrated in FIG. 6A, the left guiding element 12 is located in the inclination portion 6 and the right guiding element 12 is located in the region of the declination portion 7. A special position is illustrated in which the two guiding elements 12 each contact a part of the portions 6, 7 having the same distance to the teeth 3. Thus, there is the special situation in which the saw band 1 is not tilted with respect to the usual direction of movement of the band.

FIG. 6B now illustrates a tilted position occurring during further movement of the saw band 1. The left guiding element 12 is located at the beginning of the declination portion 7. The right guiding element 12 is located at the beginning of the inclination portion 6 of the following profiled back portion 5. Due to the fact that the back 4 in the region of the inclination portion 6 in which the right guiding element 12 is located has a smaller distance to the teeth 3 and it is located at a lower position compared to the other regions in which the left guiding element 12 is located, the saw band 1 is pivoted or tilted in a counterclockwise direction.

This tilted position is generally maintained, but it is weakened until the position illustrated in FIG. 6C is reached. In this position, the left guiding element 12 is located approximately in the middle of the declination portion 7, and the right guiding element 12 is located approximately in the middle of the following inclination portion 6. This position is the end of the position tilted in a counterclockwise direction. The teeth 3 (as far as they have the same height) are all located at the same distance with respect to the dash-dot line.

When this movement of the saw band 1 is continued, one attains a position tilted in a clockwise direction, the maximum of which is shown in FIG. 6D. The left guiding element 12 is located in the compensation portion 8. The right guiding element 12 is located at the end of the following inclination portion 6.

When this movement of the saw band 1 is continued, this tilted position is generally maintained, but it is weakened as this is shown in FIG. 6E. In FIG. 6E, the left guiding element 12 is located in the compensation portion 8 and the right guiding element 12 is located at the beginning of the following declination portion 7.

The cycle is then completed by a continued movement of the saw band 1, and the position illustrated in FIG. 6A is reached again. In the following, the next cycle begins.

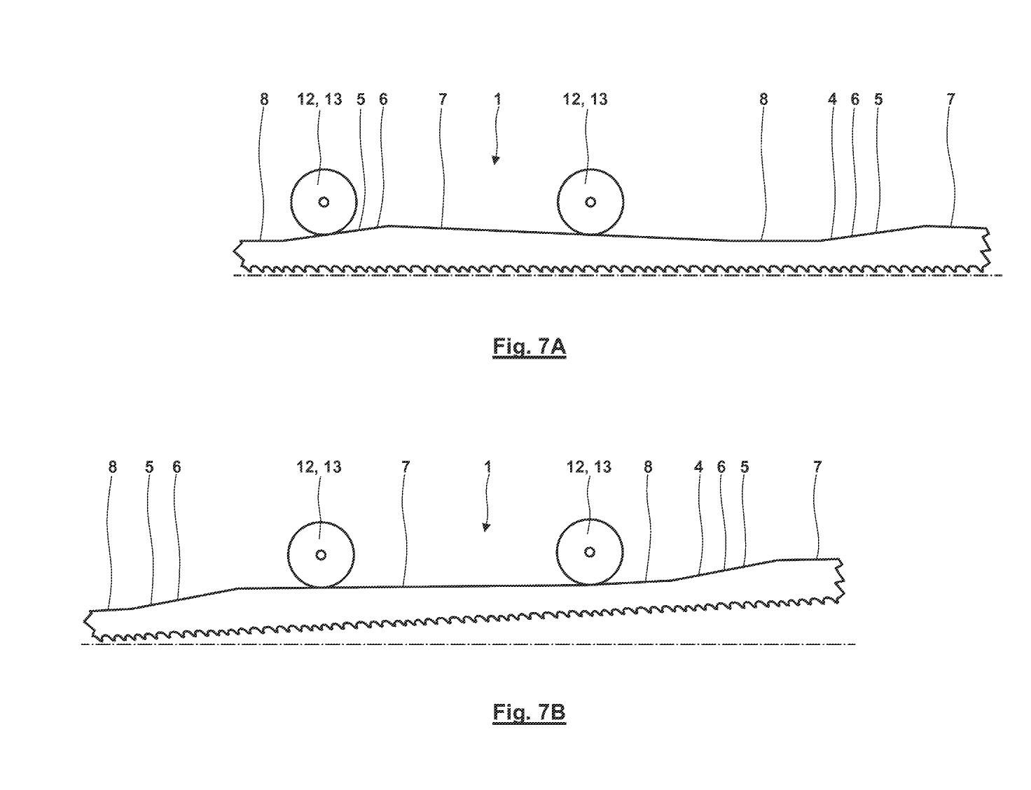

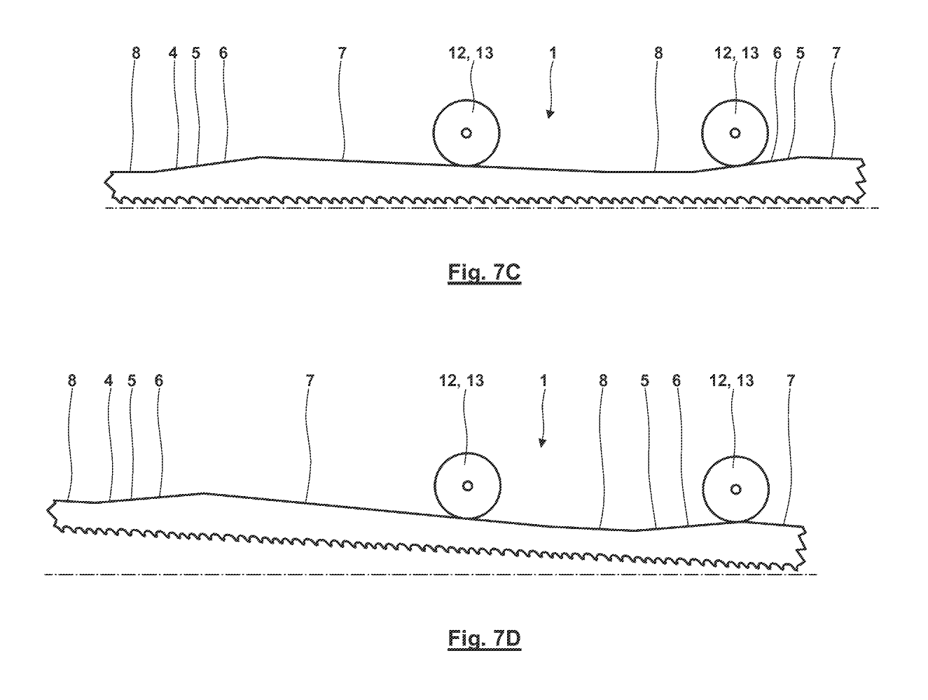

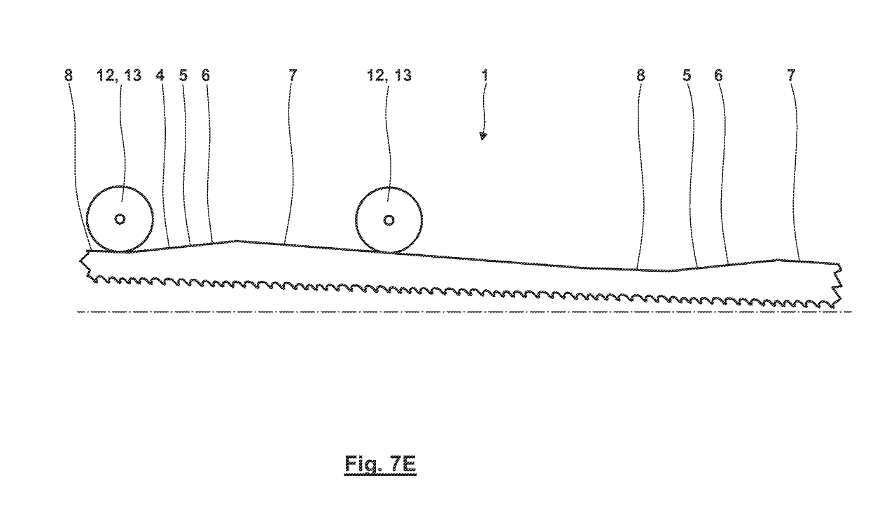

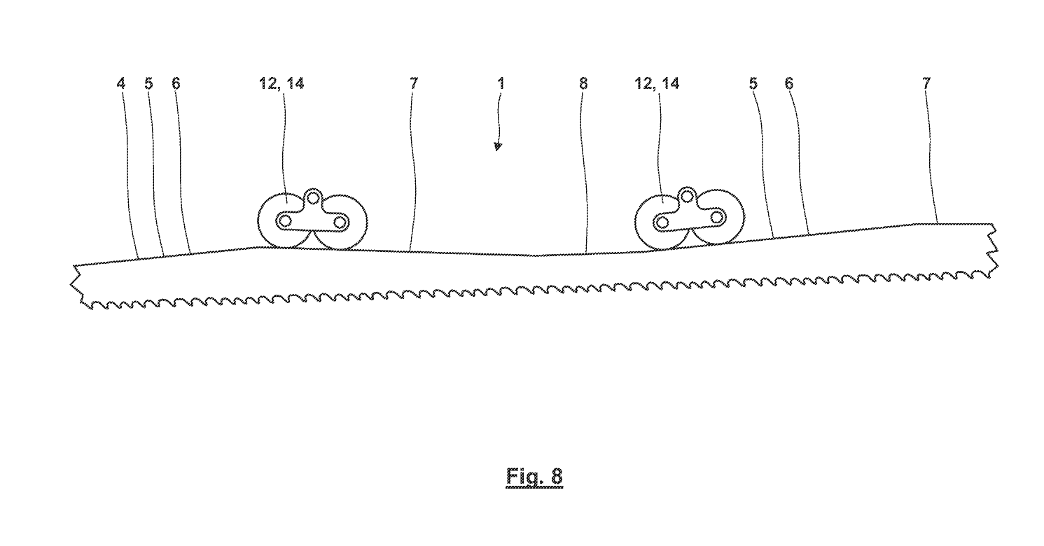

FIGS. 7A-7E illustrate the novel movement of another exemplary embodiment of the saw band 1 in a saw machine. In this case, the saw band 1 includes a back 4 having an asymmetrically profiled back portion 5. The compensation portion 8 is again designed as a lower portion. The guiding elements 12 are again designed as single rollers 13.

In the position illustrated in FIG. 7A, the left guiding element 12 contacts the back 4 of the saw band approximately in the middle of the inclination portion 6. The right guiding element 12 contacts the declination portion 7 approximately in its middle. In this way, one attains a non-tilted position of the saw band 1.

During continued movement of the saw band 1 towards the right, the saw band 1 is then tilted in a counterclockwise direction. The maximum tilted position is illustrated in FIG. 7B. In this position, the left guiding element 12 contacts the declination portion 7 and the right guiding element 12 contacts the compensation portion 8.

During continued movement of the saw band 1 towards the right, the tilted position in a counterclockwise direction is further reduced until the balanced position is reached, as it is illustrated in FIG. 7C. In this position, the left guiding element 12 is located approximately in the middle of the declination portion 7 and the right guiding element 12 is located approximately in the middle of the following inclination portion 6.

During continued movement of the saw band 1, one then attains a tilted position in a clockwise direction. The maximum tilted position is illustrated in FIG. 7D. In this position, the left guiding element 12 is located in the declination portion 7 and the right guiding element 12 is located in the upper end of the following inclination portion 6.

During continued movement of the saw band 1 towards the right, the tilted position is reduced such that e.g. the position illustrated in FIG. 7E is reached. In this position, the left guiding element 12 is located in the compensation portion 8 and the right guiding element 12 is located in the declination portion 7.

During continued movement of the saw band 1, the cycle is completed and the position illustrated in FIG. 7A is reached. In the following, the next cycle begins.

In another exemplary embodiment of the novel saw band 1 not being illustrated, the asymmetrical profiled back portion 5 has a different total length and the inclination portion 6 and the declination portion 7 each have a different length. Other designs are possible to adapt to the length of the band.

The following table lists the respective values of this exemplary embodiment:

Exemplary embodiment No. 3

| | | Value |
|---|---|---|
| Parameter | Unit | (absolute value) |
| inclination angle β_{inclination} | ° | 0.46 |
| declination angle β_{declination} | ° | 0.13 |
| length of the inclination portion L_{inclination} | mm | 150 |
| length of the declination portion L_{declination} | mm | 520 |
| length of the compensation portion L_{compensation} | mm | 80 |
| length of the profiled back portion L_{profile} | mm | 750 |
| maximum height difference ΔHₘₐₓ | mm | 1.2 |

FIG. 8 illustrates an asymmetrically profiled saw band 1 being arranged in a band saw machine not being illustrated in detail, the band saw machine including the guiding elements 12 being designed as double rollers 14. In the illustrated position, the left double roller 14 contacts the beginning of the declination portion 7. The right double roller 14 contacts the beginning of the next inclination portion 6 towards the right such that one attains a position tilted in a counterclockwise direction.

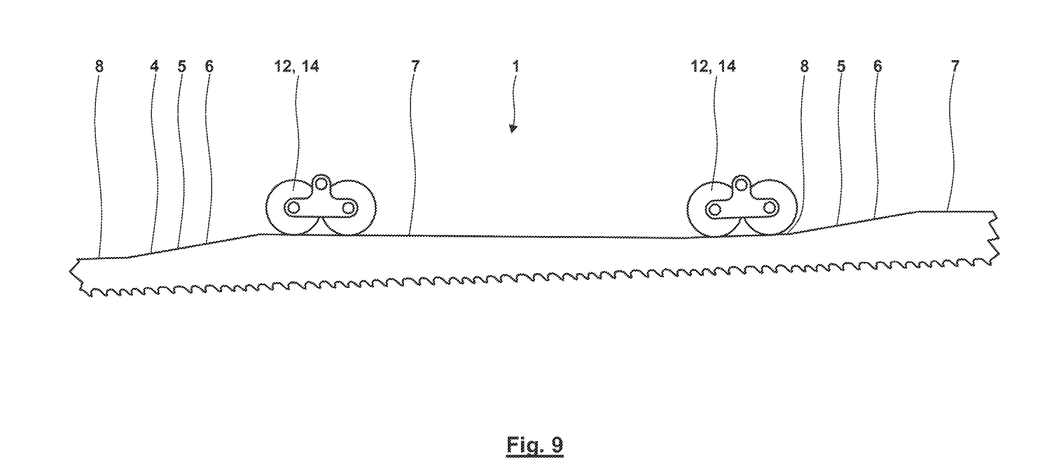

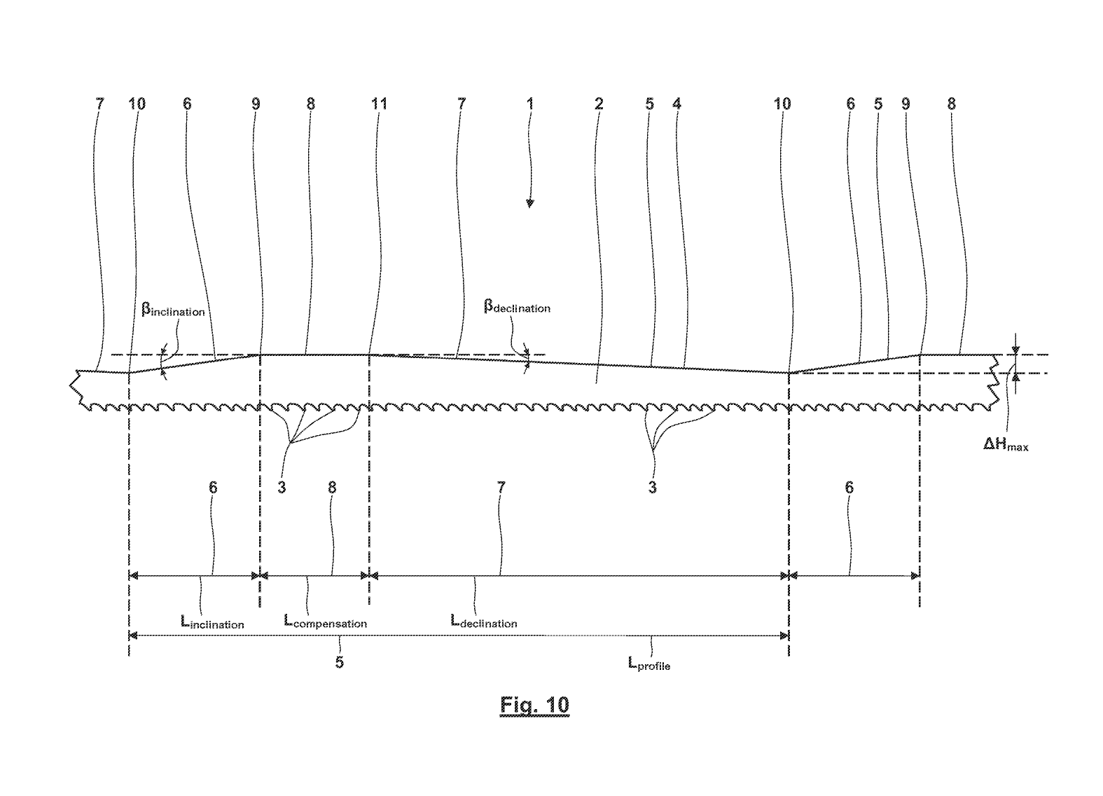

The saw band 1 illustrated in FIG. 9 includes an asymmetrically profiled back portion 5. In the illustrated position, the left double roller 14 is located at the beginning of the declination portion 7 and the right double roller 14 is located in the following compensation portion 8.

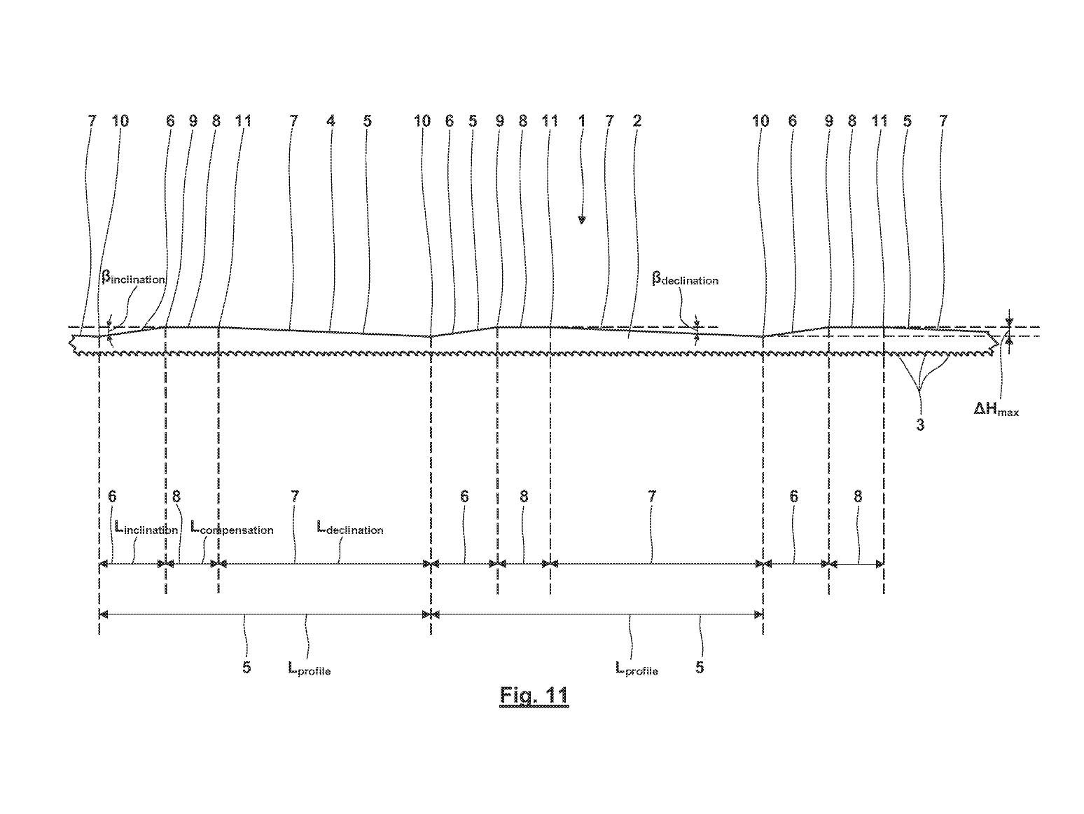

The saw band 1 illustrated in FIGS. 10 and 11 again includes an asymmetrically profiled back portion 5. In this case, the compensation portion 8 is not designed as a lowered portion, but instead as a raised portion. Thus, it is located next to the end 9 of the inclination portion 6. With this embodiment, the desired changing tilting movement of the saw band 1 is reached.

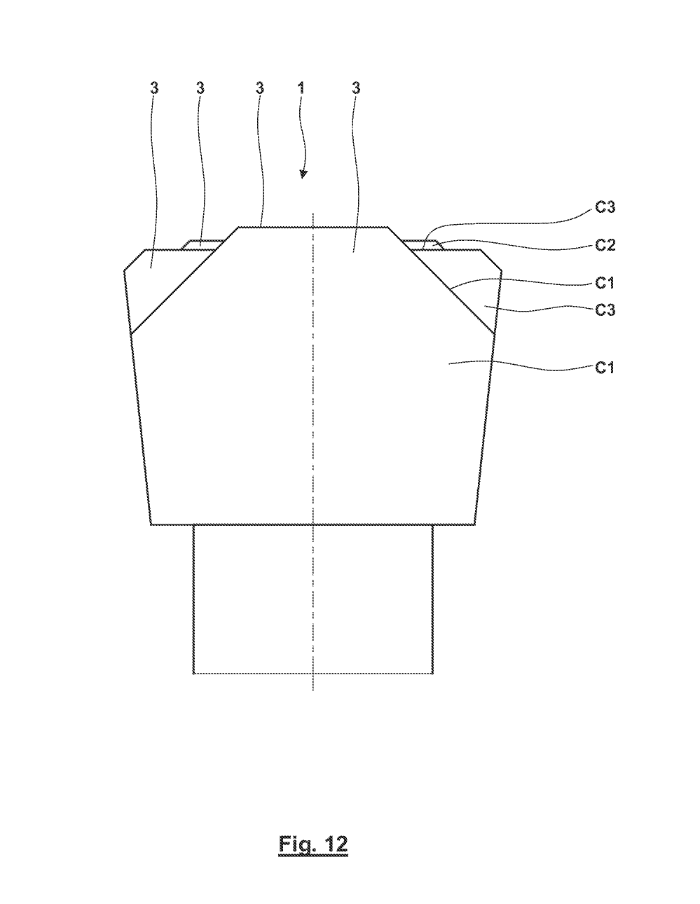

FIG. 12 illustrates an exemplary design of the teeth 3 of the saw band 1 as seen in a projection in the usual straight direction of movement of the band. A group of teeth is to be seen, the group being arranged multiple times along the length of the saw band 1.

The group of teeth includes a performance tooth C1 having the greatest height and the smallest width. This performance tooth C1 is arranged twice in the group. The performance tooth C1 that is arranged further in the back as seen in the projection cannot be seen in the illustration since it is covered by the performance tooth C1 being located further in the front. The surface tooth C3 is located behind the front performance tooth C1. This surface tooth C3 has the greatest width and the smallest height in the group. The next tooth is the further performance tooth C1. The next tooth is another performance tooth C2 having the second greatest height and the second greatest width of the teeth 3. The next tooth is another surface tooth C3 being located twice in the group. The surface tooth C3 being located further in the rear as seen in the projection cannot be seen in the illustration since it is covered by the surface tooth C3 being located further in the front. Thus, the order of teeth is C1-C3-C1-C2-C3. This series of teeth is then repeated along the length of the saw band 1.

As it is to be further seen in FIG. 12, the teeth 3 are designed as chamfered and unset teeth 3. The chamfer angle in this case is 45°, but it could also be a different value. The teeth 3 may also be designed not to be chamfered. It is to be understood that other designs and arrangement of the teeth 3 and of the group of teeth of the saw band 1 are possible.

We claim:

1. A saw band, comprising:
a tooth supporting body;
a plurality of teeth being located at the tooth supporting body; and
a back being located opposite to the teeth, the back including a profiled back portion, the profiled back portion including the following portions:
an inclination portion, the inclination portion having a first length, a first end and a first angle of inclination, the inclination portion being designed and arranged such that a distance of the back to the teeth increases in the inclination portion in a direction towards the first end of the inclination portion,
a declination portion, the declination portion having a second length, a second end and a second angle of declination, the declination portion being designed and arranged such that a distance of the back to the teeth decreases in the declination portion in a direction towards the second end of the declination portion, and
a compensation portion, the compensation portion having a third length and a third end, the compensation portion being designed not to be profiled and to be straight such that a distance of the back to the teeth is constant in the compensation portion,
a) the declination portion being located next to the first end of the inclination portion and the compensation portion being located next to the second end of the declination portion, or
b) the inclination portion being located next to the second end of the declination portion and the compensation portion being located next to the first end of the inclination portion, the third length of the compensation portion being shorter than first length of the inclination portion and the second length of the declination portion.

2. The saw band of claim 1, wherein the compensation portion is located directly between the inclination portion and the declination portion.

3. The saw band of claim 1, wherein the profiled back portion is defined by only one inclination portion, only one declination portion and only one compensation portion.

4. The saw band of claim 2, wherein the profiled back portion is defined by only one inclination portion, only one declination portion and only one compensation portion.

5. The saw band of claim 1, wherein the third length of the compensation portion is between 30 mm and 150 mm.

6. The saw band of claim 2, wherein the third length of the compensation portion is between 30 mm and 150 mm.

7. The saw band of claim 3, wherein the third length of the compensation portion is between 30 mm and 150 mm.

8. The saw band of claim 4, wherein the third length of the compensation portion is between 30 mm and 150 mm.

9. The saw band of claim 1, wherein the profiled back portion is designed according to feature a) and the third length of the compensation portion is shorter than the first length of the inclination portion and the second length of the declination portion.

10. The saw band of claim 9, wherein third length of the compensation portion is maximally 85% of the first length of the inclination portion and of the second length of the declination portion.

11. The saw band of claim 1, wherein
the first angle of inclination of the inclination portion is different than the second angle of declination of the declination portion, and
the first length of the inclination portion is different than the second length of the declination portion.

12. The saw band of claim 1, wherein
the second length of the declination portion is at least twice as long as the first length of the inclination portion, or
the first length of the inclination portion is at least twice as long as the second length of the declination portion.

13. The saw band of claim 11, wherein the third length of the compensation portion is shorter than the shorter length of the inclination portion and the declination portion.

14. The saw band of claim 12, wherein the third length of the compensation portion is shorter than the shorter length of the inclination portion and the declination portion.

15. The saw band of claim 1, wherein the saw band includes an integer plurality of profiled back portions.

16. The saw band of claim 1, wherein the saw band includes two profiled back portions having different lengths.

17. The saw band of claim 1, wherein the profiled back portion has been manufactured in a way that machining grooves are produced, the machining grooves extending in a longitudinal direction of the saw band.

18. The saw band of claim 1, wherein the tooth supporting body at a side facing away from the teeth is designed not to be profiled.

19. The saw band of claim 1, wherein the teeth are arranged in a group of teeth, the group being repeatedly arranged along the tooth supporting body, the group including:
a surface tooth having a first width and a first height, the first width being the greatest width of all teeth in the group and the first height being the smallest height of all teeth in the group, and
two performance teeth having second widths and second heights, the second widths being smaller than the first width of the surface tooth and the second heights being greater than the first height of the surface tooth.

20. The saw band of claim 19, wherein
the performance tooth having the greatest height and the smallest width is arranged more than once in the group, or
the surface tooth is arranged more than once in the group.

21. The saw band of claim 19, wherein
the performance tooth having the greatest height and the smallest width is arranged more than once in the group, and
the surface tooth is arranged more than once in the group.
